(19) United States
(12) Patent Application Publication
(10) Pub. No.: US 2005/0146743 A1
(43) Pub. Date: Jul. 7, 2005

(54) Multi-functional printer device

(76) Inventor: Jonathan Firooz, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/750,717

(22) Filed: Jan. 2, 2004

(51) Int. Cl. G06F 15/00; H04N 1/40

(52) U.S. Cl. 358/1.15; 358/448

(57) ABSTRACT

A method for receiving facsimiles in a multi-function printer device operating as a voice messaging system comprises answering, by the multi-function printer device, an incoming phone call, playing, by the multi-function printer device, an outgoing message, monitoring, by the multi-function printer device, the incoming phone call for a facsimile tone while playing the outgoing message, recording, by the multi-function printer device, an incoming message when no facsimile tone is detected, and ceasing playing of the outgoing message by the multi-function printer device in response to the facsimile tone and initializing the multi-function printer device to receive an incoming facsimile transmission.

### CROSS-REFERENCE TO RELATED APPLICATIONS

This Application is related to commonly assigned and concurrently filed U.S. patent application Ser. No. ______ [Attorney Docket No. 200205925-1] entitled “MULTI-FUNCTIONAL PRINTER DEVICE”; and Ser. No. ______ [Attorney Docket No. 200205923-1] entitled “MULTI-FUNCTIONAL PRINTER DEVICE”; the disclosures of which are incorporated herein by reference.

### FIELD OF THE INVENTION

The present invention is broadly related to multi-function printers, and more specifically to systems and methods for receiving facsimiles in a multi-function printer device operating as a voice messaging system.

### DESCRIPTION OF RELATED ART

Initially, facsimile, or fax, technology was primarily developed for commercial use as a means of transmitting copies of documents without employing conventional mail or courier services. The standard fax machine can be connected to a dedicated telephone line that is not shared by any other device, such as an answering machine in a consumer setting, or even a credit card reader in a commercial setting. For some businesses it is typically not a great burden to pay a few extra dollars per month for a separate line for a critical device such as a fax machine.

However, it is becoming more common and more useful for consumers and small businesses to have fax capability. Yet, consumers and small businesses that cannot dedicate a line to a fax machine may have additional burdens. For example, conflicts can arise between an answering machine and a traditional fax machine in that most fax machines will answer after a certain number of rings, in a fashion similar to a typical answering machine. Thus, in unattended situations, one device will pick-up, preempting operation of the other device. In some instances, consumers and small businesses that cannot dedicate a line to a fax machine may either receive voice messages or unattended faxes, but not both.

Modern multi-function printers, also known as all-in-one devices, may include fax, as well as copy, scan and print capability. A user wanting to use the fax functionality of a multi-function printer device would typically either turn off their answering machine when they expect a fax, or conversely turn off the fax when they expect a voice message, unless they subscribe to separate phone lines for each device.

### BRIEF SUMMARY OF THE INVENTION

An embodiment of a method for receiving facsimiles in a multi-function printer device operating as a voice messaging system comprises answering, by the multi-function printer device, an incoming phone call, playing, by the multi-function printer device, an outgoing message, monitoring, by the multi-function printer device, the incoming phone call for a facsimile tone while playing the outgoing message, recording, by the multi-function printer device, an incoming message when no facsimile tone is detected, and ceasing playing of the outgoing message by the multi-function printer device in response to the facsimile tone and initializing the multi-function printer device to receive an incoming facsimile transmission.

An embodiment of a multi-function printer device comprises means for printing media, means for optically scanning media, means for answering incoming phone calls, the answering means comprising means for playing an outgoing message and means for recording an incoming message, means for sending and receiving facsimiles, means for monitoring the incoming phone calls, while the means for playing plays the outgoing message, for a facsimile tone, and means for initializing the facsimile means to receive an incoming facsimile transmission in response to the monitoring means detecting a facsimile tone.

An embodiment of a system for providing a multi-function printer device a capability for receiving fax transmissions and providing voice messaging comprises a multi-function printer device comprising a printer, an optical scanner, a call answering functionality and a facsimile functionality, wherein the multi-function printer device monitors incoming phone calls to internally intercept and initialize the facsimile functionality to receive incoming facsimile transmissions while the call answering functionality is processing a call, and the system comprises a general purpose processor-based device selectively interfaced with the multi-function printer device and selectively powered.

### BRIEF DESCRIPTION OF THE DRAWINGS

FIG. 1 illustrates a system employing an embodiment of the present invention; and

FIG. 2 is a flowchart of an embodiment of the present invention.

### DETAILED DESCRIPTION

The present inventive systems and methods provide a multi-function printer device with a capability to function as both a fax machine and as an answering machine. The multi-function printer device may also provide other functions such as printing, scanning and copying in an “all-in one” configuration. Thus, the present systems and methods preferably employ fax receive capability, as well as a capability for storing an outgoing message to callers and storing incoming messages left by callers. The present systems and methods also preferably have a capability to intelligently monitor incoming calls to determine whether the incoming call is a fax transmission or a voice transmission and to switch the call appropriately, internally.

A multi-function printer device in accordance with the present invention, after a set number of incoming rings, picks up an incoming call, and acts as an answering machine by starting to play an outgoing message recorded by the user of the multi-function printer device. While the outgoing message is playing, the multi-function printer device simultaneously monitors the incoming line for any sort of signals and if the multi-function printer device detects the presence of a fax tone, indicating a fax transmission is being sent, the multi-function printer device will stop playing the outgoing message and start responding and synchronizing with the sending facsimile device to receive the fax message. If the present multi-function printer device does not detect a fax tone, upon completion of the outgoing message, the multi-function printer device starts recording an incoming voice message.

Whereas some fax machines do not employ a fax tone, an alternative embodiment of the present invention may also monitor for incoming sound, such as a voice, during recording of a message. If no sound is detected, the present systems and methods may initiate a fax receive lest a sending fax machine is not employing an initiating fax tone.

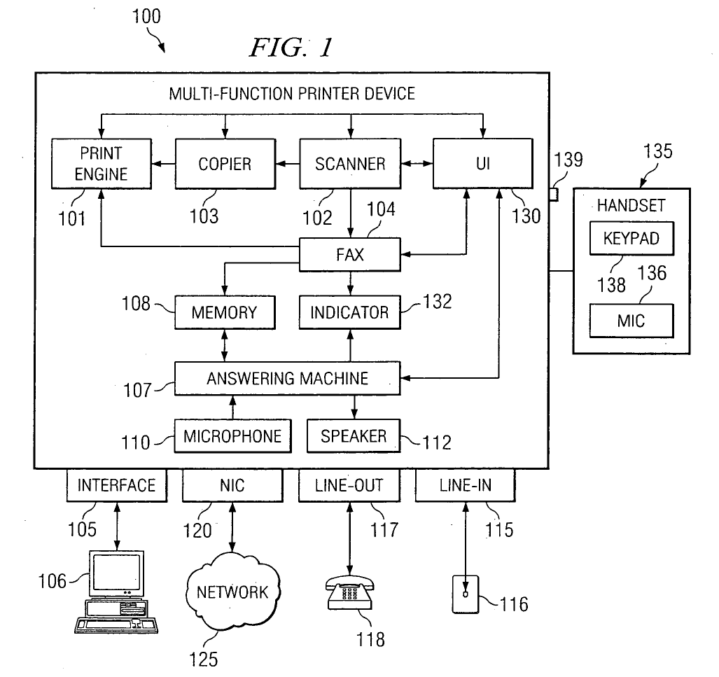

The present invention preferably employs a voice mail or answering machine built into the multi-function printer device. In one exemplary embodiment the multi-function printer device is an all-in-one device providing a “5-in-one device” or the like. FIG. 1 is a diagrammatic illustration of an embodiment of multi-function printer device 100 provided in accordance with embodiments of the present invention. Multi-function printer device 100 has a print engine or media printing functionality 101 and media scanning functionality 102. Printing functionality 101 may be of several media printing types known in the art, such as laser or inkjet and may be black-and-white (grayscale) or color. Scanning functionality 102 may include technologies such as a flatbed optical scanner, a picture frame scanner, or the like. Preferably, printing and scanning functionalities 101 and 102 may be used in conjunction with connected general purpose processor-based device 106, such as a personal computer (PC) or the like. Also, scanning functionality 102 and printing functionality 101 together may provide copier functionality 103 either in a stand-alone fashion and/or in conjunction with connected general purpose processor-based device 106. Fax functionality 104 may use printing functionality 101 for printing received faxes, and fax functionality 104 may receive scanned images from scanning functionality 102 to be used as outgoing faxes. Multi-function printer device 100 preferably has interface 105 for optionally interfacing with general purpose processor based device 106. Interface 105 may take the form of a parallel port, Universal Serial Bus (USB) port, FireWire (IEEE 1394) port, or the like. However, multi-function printer device 100 may operate as a stand-alone device, at least as an integrated stand-alone copier, fax and answering system device, without the need to be connected to general purpose processor based device 106, or without any need for general purpose processor based device to be in a powered-on status, if connected.

As noted above, multi-function printer device 100 also includes voicemail or answering system 107 that provides outgoing messages and records incoming messages. Memory 108 may be used to store an outgoing voice message(s), incoming voice messages, and/or scans and faxes. Memory 108 may take the form of volatile memory such as Random Access Memory (RAM), nonvolatile memory such as Read Only Memory (ROM) and/or Erasable Programmable read only Memory (EPROM) or a combination of volatile and nonvolatile memory. A combination of volatile and nonvolatile may, for example, use volatile memory to store transient data such as incoming voice messages or faxes while nonvolatile memory may be used to store more permanent data such as an outgoing greeting(s), default greetings and/or device settings. Memory 108 may be in addition to typical RAM or other memory associated with printer, scanner and/or copier functionality 101, 102 and/or 103. Memory 108 is preferably internal to multi-function printer device 100. However, RAM or other memory associated with general purpose processor based device 106 may also or alternatively be employed to store an outgoing voice message(s), incoming voice messages and/or scans and faxes. Multi-function printer device 100 may additionally, or alternatively, include one or more slots to receive memory devices such as smart media, compact flash, IC media, or the like, for storing messages and/or faxes in addition to more conventional uses such as providing pictures to printer functionality 101 directly. Alternatively, if multi-function printer device 100 is connected to general purpose processor based device 106 and purpose processor based device 106 is powered on, purpose processor based device 106's hard drive or other storage media may be used to store messages and/or faxes. Thereby, purpose processor based device 106 may be used to play the messages back or display the faxes at a later time. Multi-function printer device 100 may also include microphone 110 that may be used to record outgoing messages. Speaker 112 may be used during playback of messages or when screening calls, particularly when purpose processor based device 106 is not used in conjunction with multi-function printer device 100 for message playback and call screening.

Phone line-in 115 is preferably connected to a wall phone jack 116 or the like and phone line-out 117 may optionally be connected to telephone 118 or the like. Phone line-in 115 and phone line-out 117 may be decoupled in present multi-function printer device 100. Network interface 120, such as an Ethernet port, may also be provided by multi-function printer device 100 to provide interconnectivity to network 125 such as a wired local area network, a wide area network or the Internet. Multi-function printer device 100 may also, or alternatively, employ one or more wireless technologies such as IEEE 802.11 wireless networking, BULETOOTH™, infrared (IR), or the like, to provide connectivity with general purpose processor-based device 106, network 125 and/or other devices or services such as a Personal Digital Assistant (PDA), a wireless local area network, and/or the like.

As noted above, embodiments of multi-function printer device 100 may be used as a stand-alone device. User interface (UI) 130 may facilitate such stand-alone operation, and preferably may also be employed when the present multi-function printer device is employed in conjunction with general purpose processor-based device 106. Interface 130 may, among other functions related to printing, scanning and copying, facilitate sending of faxes and manual receiving of faxes, as well as providing an interface for user selection of device settings, recording of one or more outgoing greeting messages, retrieval of voice messages, downloading of faxes or messages to memory devices, and/or other operations related to multi-function printer device 100. Alternatively or additionally, a user interface may be provided on general purpose processor-based device 106. A computer provided UI may utilize a microphone and/or speaker system associated with general purpose processor-based device 106 rather than (or in addition to) employing microphone 110 and speaker 112 of multi-function printer device 100. The computer provided UI may alternatively or additionally be used to set-up the present multi-function printer device. However, once set-up using the computer provided UI, multi-function printer device 100 would still preferably be able to function as a stand-alone device without the computer turned on and/or connected, only using the computer provided UI for configuration changes. Also, as a default, multi-function printer device 100 is preferably enabled to function as a fax and answering system without any configuration using UI 130 or a computer provided UI, through the use of default settings and greetings. Indicator 132, that may be a part of UI 130, may provide a visual and/or audio indication of one or more stored faxes and/or voice messages.

Alternatively, phone handset 135 may be associated with multi-function printer device 100 and/or its answering machine functionality. Microphone 136 of handset 135 may be used rather than microphone 110 for recording answering machine outgoing messages and the like. Alternatively, a keypad 138 associated with handset 135 may be incorporated into handset 135 or may be disposed on the body of multi-function printer device 100, such as in a multi-function keypad employed by multi-function printer device 100 as part of user interface 130 or a special purpose phone keypad disposed in association with a handset receptive structure and/or hook switch 139.

When multi-function printer device 100 is connected to a standard phone line the multi-function printer device preferably operates like a standard answering machine from a user's perspective, i.e., the multi-function printer device picks up the line after a set number of rings. Once multi-function printer device 100 detects the appropriate number of rings have elapsed, the multi-function printer device picks up the line and operates as an answering machine by playing an outgoing message, such as may be recorded by the user. While playing the outgoing message, multi-function printer device 100 also monitors the line for sounds coming from the caller. If the call is from a person, the multi-function printer device will preferably continue in an answering machine mode. However, if the call is from a fax machine, the multi-function printer device will detect a standard tone sent by fax machines upon transmission. If this tone is detected, the multi-function printer device will preferably stop playing the outgoing message and connect to the call in a fax reception mode.

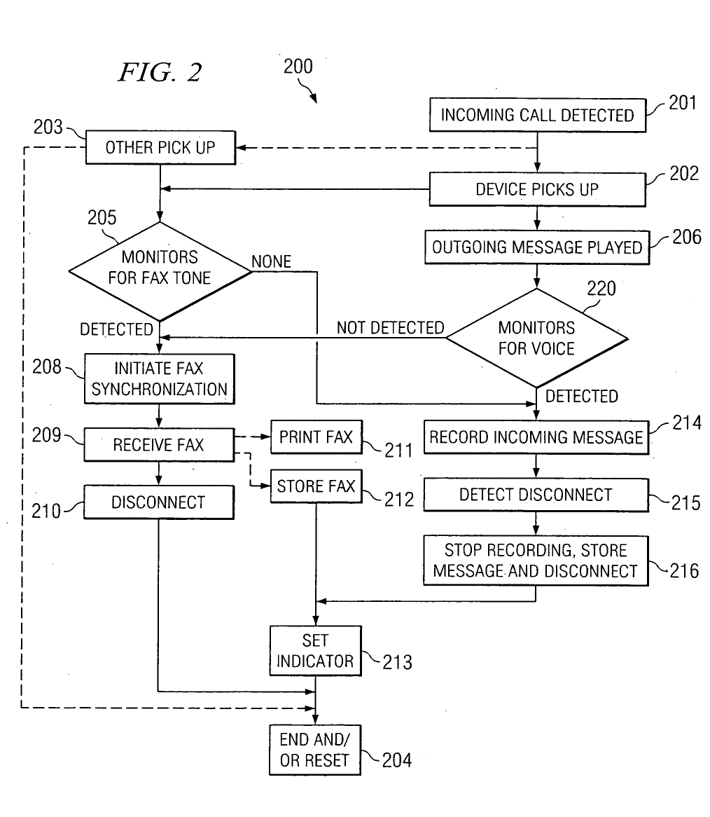

FIG. 2 flowcharts operation of an exemplary embodiment of present method 200 for providing an “all-in-one” multi-function printer device a capability for receiving fax calls and providing voice messaging. An incoming call is detected at 201. After a set number of rings, the multi-function printer device picks up the call at 202. Preferably, the number of rings may either be set by the user or preset in the multi-function printer device as a default. However, if the call is picked up at 203 by someone or at some other point, such as a connected telephone or a telephone extension on the same line as the multi-function printer device, before the preset number of rings, the multi-function printer device may end the cycle at 204 and resets. However, for a call picked up before the preset number of rings, picked up during playing of the outgoing message, or picked up during recording of an incoming message, the multi-function printer device preferably continues to monitor the line at 205, for at least a time, to detect any fax tone present.

If the set number of rings is reached, the multi-function printer device picks up at 202 and provides answering machine or voice mail functionality in which the multi-function printer device plays an outgoing message at 206. While playing the outgoing message, the multi-function printer device monitors the line for activity such as a fax tone at 205. If the multi-function printer device recognizes a fax tone on the incoming line at 205, either before or after the outgoing message finishes, the multi-function printer device initiates a fax synchronization at 208 and receives the fax message at 209. Preferably, the multi-function printer device then disconnects from the line-in at 210, ending the cycle and resetting at 204. The multi-function printer device may print the received fax document at 211 prior to, concurrently with or following disconnection at 210.

Alternatively, rather than printing the fax at 211, the multi-function printer device may store the received fax in memory at 212, or both print (211) and store (212) the received fax. The multi-function printer device may store the received fax at 212 concurrently with receipt of the fax at 209, prior to disconnect 210, concurrently with disconnect 210 or following disconnect 210. Preferably, if a fax is stored at 212 an audio and/or visual indicator is set at 213 prior to resetting the multi-function printer device at 204. As a further alternative, if the multi-function printer device is out of paper or otherwise incapable of printing at the time a fax is received, the multi-function printer device may store an incoming fax in memory. As yet another alternative, an option to save, print, or both print and save a fax to memory, may be a user settable or selectable feature.

If the multi-function printer device does not detect a fax tone at 205, the multi-function printer device continues playing the outgoing message then switches to recording an incoming message at 214 upon completion of the outgoing message. The multi-function printer device subsequently detects a disconnect on the line by the caller at 215, stops the recording, stores the incoming message in memory and disconnects at 216, ending the cycle at 204 and resetting. As noted above, embodiments of the present invention may monitor the line following the completion of outgoing message at 220 for incoming activity, such as a voice. If no activity is detected at 220, the present systems and methods may initiate a fax receive at 208 in an attempt to synchronize with a sending fax machine that is not employing an initiating fax tone.

As noted above, the memory used to store a received fax or message may be memory resident in the multi-function printer device, or memory/storage associated with a connected general purpose processor based device, such as a PC. Resident memory may be shared by various functionalities of the present multi-function printer device. The multi-function printer device may also provide forwarding functions for received faxes and/or voice messages. Additionally or alternatively, the present multi-function printer device may afford an ability to download faxes and/or messages to a connected PC, facilitating conversion and or forwarding of received faxes or messages via email or the like.

1. A method for receiving facsimiles in a multi-function printer device operating as a voice messaging system, said method comprising:
answering, by said multi-function printer device, an incoming phone call;
playing, by said multi-function printer device, an outgoing message;
monitoring, by said multi-function printer device, said incoming phone call for a facsimile tone while playing said outgoing message;
recording, by said multi-function printer device, an incoming message when no facsimile tone is detected; and
ceasing playing of said outgoing message by said multi-function printer device in response to said facsimile tone and initializing said multi-function printer device to receive an incoming facsimile transmission.

2. The method of claim 1 further comprising:
continuing to monitor said incoming call, by said multi-function printer device, for a facsimile tone, after said outgoing message completes.

3. The method of claim 1 further comprising:
monitoring, by said multi-function printer device, for sound during said recording; and
initializing said multi-function printer device to receive an incoming facsimile transmission in response to no sound being detected during said monitoring during said recording.

4. The method of claim 1 further comprising:
printing a received facsimile by said multi-function printer device.

5. The method of claim 1 further comprising:
storing a received facsimile.

6. The method of claim 5 wherein said storing further comprises storing said received facsimile in memory of said multi-function printer device.

7. The method of claim 5 wherein said storing further comprises storing said received facsimile in memory of a general purpose processor based device connected to said multi-function printer device.

8. The method of claim 1 wherein said answering occurs after a predetermined number of rings, and said predetermined number of number of rings are preset in said multi-function printer device.

9. The method of claim 8 wherein said predetermined number of number of rings are selected by a user of said multi-function printer device.

10. A multi-function printer device comprising:
means for printing media;
means for optically scanning media;
means for answering incoming phone calls, said answering means comprising means for playing an outgoing message and means for recording an incoming message;
means for sending and receiving facsimiles;
means for monitoring said incoming phone calls, while said means for playing plays said outgoing message, for a facsimile tone; and
means for initializing the facsimile means to receive an incoming facsimile transmission in response to said monitoring means detecting a facsimile tone.

11. The multi-function printer device of claim 10 wherein said monitoring means comprises means for continuing to monitor said incoming call for a facsimile tone during playback of said outgoing message.

12. The multi-function printer device of claim 10 wherein said monitoring means comprises means for continuing to monitor said incoming call for a facsimile tone after said outgoing message completes.

13. The multi-function printer device of claim 10 wherein said monitoring means comprises means for initializing the facsimile means to receive an incoming facsimile transmission in response to no sound being detected during recording of an incoming message.

14. The multi-function printer device of claim 10 wherein said device is adapted to employ the facsimile means and said answering means independent of a connection to a general purpose processor-based device.

15. The multi-function printer device of claim 10 further comprising means for receiving at least one memory device and means for downloading received faxes to said memory device.

16. The multi-function printer device of claim 10 further comprising means for receiving at least one memory device and means for downloading received messages to said memory device.

17. The multi-function printer device of claim 10 wherein said scanning means comprises a flatbed optical scanner.

18. The multi-function printer device of claim 10 wherein said scanning means comprises a picture frame scanner.

19. The multi-function printer device of claim 10 further comprising means for copying media as a combination of said printing means and said scanning means.

20. A system for providing a multi-function printer device a capability for receiving fax transmissions and providing voice messaging, said system comprising:
a multi-function printer device comprising:
a printer;
an optical scanner;
a call answering functionality; and
a facsimile functionality;
wherein said multi-function printer device monitors incoming phone calls to internally intercept and initialize said facsimile functionality to receive incoming facsimile transmissions while said call answering functionality is processing a call; and
a general purpose processor-based device selectively interfaced with said multi-function printer device and selectively powered.

21. The system of claim 20 wherein said facsimile functionality stores said incoming facsimiles to memory of said general purpose processor-based device.

22. The system of claim 20 wherein a microphone associated with said general purpose processor-based device is used to record an outgoing message for use by said call answering functionality.

23. The system of claim 20 wherein a speaker associated with said general purpose processor-based device is used for playing incoming messages.

24. The system of claim 20 wherein said general purpose processor-based device hosts a user interface adapted to receive user settings for said multi-function printer device.

25. The system of claim 24 wherein said user interface enables recording of an outgoing message for use by said call answering functionality.

26. The system of claim 20 wherein said a multi-function printer device is a stand-alone device adapted to employ said facsimile and call answering functionalities independent of said interface with said general purpose processor-based device.

27. The system of claim 20 wherein said multi-function printer device is a stand-alone device adapted to employ said facsimile and call answering functionalities independent of a power status of said general purpose processor-based device.

28. The system of claim 20 wherein said multi-function printer device further comprises a wireless interface, interfacing said general purpose processor-based device with said multi-function printer device.
